(19) United States
(12) Patent Application Publication
(10) Pub. No.: US 2026/0296303 A1
(43) Pub. Date: Oct. 1, 2026

(54) Lighting Device for a Motor Vehicle

(71) Applicant: Bayerische Motoren Werke Aktiengesellschaft, Muenchen (DE)

(72) Inventors: Harald LATHWESEN, Mauern (DE); Alexander STUCKERT, Muenchen (DE); Kathrin WALCH, Freising (DE)

(21) Appl. No.: 19/480,857

(22) PCT Filed: Aug. 14, 2024
(86) PCT No.: PCT/EP2024/072848

§ 371 Date: Nov. 3, 2025

(30) Foreign Application Priority Data
Aug. 18, 2023 (DE) 10 2023 122 119.1

(51) Int. Cl. B60Q 3/233; B60K 35/21; B60Q 3/74

(52) U.S. Cl. CPC B60Q 3/233; B60K 35/21; B60Q 3/74; B60K 2360/334; B60K 2360/66

(57) ABSTRACT

A lighting device for a motor vehicle includes a vehicle seat for an occupant of the motor vehicle. The vehicle seat includes a seat element with a seat surface and a backrest. The backrest has a rear wall having an inner face and an outer face. The rear wall extends from a first end which is arranged adjacent to the seat element, to a second end which is arranged at a distance from the seat element. A projection module is installed in the vehicle seat. This projection module is fixed to the inner face of the rear wall in a fastening position, so that light, which is generated by the projection module during operation of the projection module, exits from a light exit opening in the rear wall, in order to generate a light projection in a projection region on the outer face of the rear wall.

### BACKGROUND AND SUMMARY

The invention relates to a lighting device for a motor vehicle and, in particular, to a lighting device that comprises a projection module which is installed in a vehicle seat.

Interior lightings for motor vehicles, which generate light projections on components in the interior of the motor vehicle, are known from the prior art. The document DE 10 2021 006 486 A1 describes a vehicle seat with an illumination system that comprises a projector. The projector is designed to generate an image on an illumination surface that accommodates a passenger. The light of the projector is transmitted through a transparent medium in the vehicle seat.

It is an object of the invention to provide a lighting device for a motor vehicle, which is integrated in a vehicle seat and reliably generates a light projection on a surface that is not concealed by the occupant sitting on the vehicle seat.

This object is achieved by the lighting device according to the claimed invention.

The lighting device according to embodiments of the invention is intended for a motor vehicle. The motor vehicle is in particular an automobile, although it may optionally also be a truck. The lighting device comprises a vehicle seat for an occupant of the motor vehicle, the vehicle seat preferably being the driver's seat or the front passenger seat of the motor vehicle. In a manner known per se, the vehicle seat contains a seat element having a seating surface and a backrest. The thighs and the bottom of the occupant who is sitting on the vehicle seat are supported on the seating surface of the seat element. The back of the occupant extends along the backrest. The backrest has a rear wall with an inner side and an outer side, the rear wall being in particular a component formed in one piece. The rear wall extends from a first end, which is arranged next to the seat element, to a second end which is arranged away from the seat element. When the vehicle seat is properly installed in the motor vehicle, the first end is the lower end of the backrest and the second end is the upper end of the backrest. A projection module is further installed in the vehicle seat

The lighting device according to embodiments of the invention is distinguished in that the projection module is fixed to the inner side of the rear wall in a fastening position so that light which is generated by the projection module during its operation emerges from a light exit opening in the rear wall in order to generate a light projection in a projection region on the outer side of the rear wall. The light projection is therefore a visible light distribution on the rear side of the vehicle seat.

The term fixing the projection module to the inner side of the rear wall is intended to mean that the projection module is fastened rigidly to the inner side of the rear wall, or is connected rigidly to the inner side of the rear wall. The projection module need not be in direct contact with the inner side of the rear wall, and it may instead be fastened, or connected, rigidly to the inner side of the rear wall indirectly by a fastener, for example by the holder described below.

The lighting device according to embodiments of the invention has the advantage that the light projection is always generated reliably at the same place on the vehicle seat, regardless of the position of the backrest. The projection onto the rear wall through a light exit opening ensures that the light distribution is not concealed by an occupant who is sitting on the vehicle seat, and neither is it masked by other components in the motor vehicle. Further, the projection module is integrated compactly in the interior of the vehicle seat.

In one preferred variant, the light of the projection module impinges directly on the light exit opening. Nevertheless, it is optionally also possible that the light of the projection module initially impinges on an optical instrument, in particular a mirror, which deviates this light toward the light exit opening. In a further preferred variant, the projection module contains a control instrument with which an image to be projected is adapted in such a way that it generates an undistorted light projection in the projection region.

In the lighting device according to embodiments of the invention, any desired projection module known from the prior art may be used as the projection module. In particular, the projection module may comprise a DMD device for generating the projection (DMD =Digital Mirror Device). Further, the projection module may be a scanning projection instrument which generates the light projection by moving a light beam, for example a laser beam.

In one preferred variant, the lighting device according to the invention is configured in such a way that the light emerging from the light exit opening impinges exclusively on the projection region. In other words, no region of the motor vehicle other than the projection region is illuminated by the light of the projection module. It is thereby possible to ensure that the light projection does not impinge on other components in the motor vehicle or parts of the body of an occupant in the motor vehicle.

In a further preferred embodiment, the light exit opening is directed toward the first end of the rear wall, i.e. downward when the vehicle seat is properly installed in the motor vehicle. This ensures that the light exit opening cannot be seen directly by a vehicle occupant.

In one particularly preferred embodiment, the rear wall of the vehicle seat is shaped in such a way that the smallest angle of incidence at which the light that generates the light projection impinges on the projection region lies between 10° and 15°. This ensures a sufficiently large angle of incidence for the light, so that distortions can be avoided, or eliminated easily from the light projection by back-calculation with a corresponding control instrument in the projection module.

In a further preferred embodiment, a recess, in which the projection region is located, is formed in the outer side of the rear wall. In this way, compact dimensions of the vehicle seat are obtained. In particular, the legroom for a person sitting behind the vehicle seat is increased.

In one preferred variant of the embodiment just described, the light exit opening is provided in an edge region of the recess that lies opposite an oblique portion of the recess, the oblique portion being inclined relative to the light exit opening at an angle of inclination of less than 90° and containing the projection region. With this shaping, a large-area light projection with low distortions can be obtained.

In a further preferred embodiment, the projection module of the lighting device according to the invention is accommodated in a holder that is applied to the inner side of the rear wall. Preferably, the holder is fastened to a plurality of protrusions provided on the rear wall. These protrusions are preferably formed integrally with the rear wall. Such a holder can ensure simple installation of the projection module in the vehicle seat.

In a further advantageous configuration, an alignment device for varying the fastening position of the projection module is further provided, in order to vary the direction of the light emerging from the light exit opening and thereby the projection region on the outer side of the rear wall. The projection module may thereby be used flexibly for different shapes of rear walls by adapting the projection region. In one preferred embodiment, the alignment device is provided on the holder described above.

In a further preferred configuration, the alignment device comprises one or more settable adjustment elements, which mechanically interact with the holder in such a way that a variation of the fastening position of the projection module can be achieved by setting the adjustment element(s). This ensures simply constructed mechanical setting of the fastening position of the projection module.

In one preferred embodiment, the holder has a holding portion to which the projection module is fastened, a resiliently deformable portion of the holder being adjacent to a first end of the holding portion and the adjustment element or elements engaging in the holding portion at the second end of the holding portion, which lies opposite the first end. By setting the adjustment element or elements, the variation of the fastening position of the projection module can in this case be achieved by varying a resilient deformation of the resiliently deformable portion. The function of aligning the projection module can thereby be integrated compactly into the holder.

In one preferred variant, the resiliently deformable portion is connected to a base portion of the holder, the base portion in turn being fastened to the inner side of the rear wall. Preferably, the projection module is accommodated between the holding portion and the base portion.

In a further embodiment, each adjustment element is an adjustment screw having a first end and an opposite second end, the screw head at which the adjustment screw can be turned manually, preferably with a tool, being located at the first end.

Preferably, each adjustment screw is screwed in the holder and comprises a thickening at its second end, the thickening being held in a mount at the second end of the holding portion. A force that the respective adjustment screw exerts on the holding portion can be varied by turning the respective adjustment screw, so that the variation of the fastening position of the projection module can be achieved by varying the resilient deformation of the resilient portion. In this embodiment, it is possible to use an adjustment screw known per se with a thickening, which is formed for example as a spherical head, for varying the fastening position of the projection module.

In a further preferred embodiment, the rear wall of the vehicle seat is a plastic component, in particular an injection molded component. This allows simple production of the rear wall by injection molding.

In a further preferred embodiment, the projection module is configured in such a way that an animated light projection is generated in the projection region. Furthermore, a memory in which various digital images, and optionally animated digital images, for generating different light projections are stored, may be provided in the projection module. A corresponding digital image and therefore a desired light projection may in this case be displayed according to particular criteria, or by a user action. Optionally, the projection module may also have an interface for saving new digital images for new light projections in the projection module. A user may for example purchase the new digital images via a digital after-sales service, the purchased images then being transmitted from a backend to the projection module. The projection module may likewise be configured in such a way that new digital images for new light projections are installed on the projection module by a user via their terminal device.

Besides the lighting device described above, the invention also relates to a motor vehicle which comprises one or more of the lighting devices according to embodiments of the invention.

Exemplary embodiments of the invention are described in more detail below with the aid of the appended figures.

### BRIEF DESCRIPTION OF THE DRAWINGS

FIG. 1 shows a perspective view from behind of one embodiment of a vehicle seat according to the invention with a projection module integrated therein.

FIG. 2 shows a sectional view along the driving direction, which illustrates the profile of the rear wall of the vehicle seat of FIG. 1 and the position of the projection module installed therein.

FIG. 3 shows a perspective view from the front of the vehicle seat of FIG. 1.

FIG. 4 shows a detail view of FIG. 3, which illustrates the fastening of the projection module in the vehicle seat.

FIG. 5 shows a perspective view from behind, which shows the holder of FIG. 4 without a projection module provided therein.

FIG. 6 shows a perspective view from behind, which shows the projection module of FIG. 4 without a holder.

FIG. 7 shows a perspective representation from behind, which depicts the holder with a projection module accommodated therein.

### DETAILED DESCRIPTION OF THE DRAWINGS

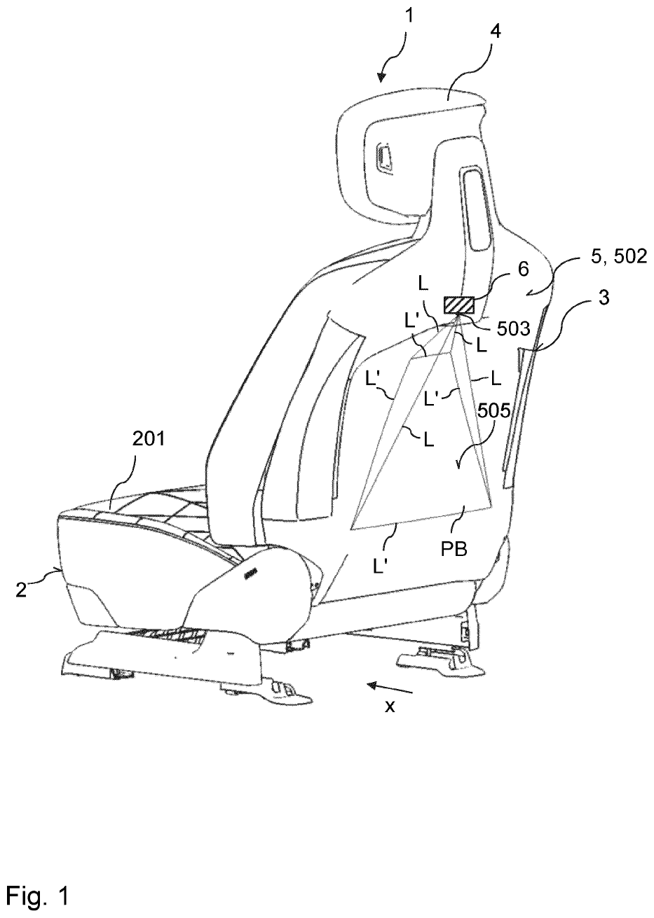

An exemplary embodiment of the invention is described below with the aid of a vehicle seat in a motor vehicle in the form of an automobile; the vehicle seat may be the driver's seat or the front passenger seat. In FIGS. 1 to 4, the driving direction of the motor vehicle in relation to the vehicle seat is indicated as an arrow x so as to reflect the way in which the vehicle seat is installed in the motor vehicle. A view from behind corresponds to a view in the driving direction, and a view from the front corresponds to a view counter to the driving direction.

In FIG. 1, the vehicle seat is denoted by the reference 1. In a manner known per se, it comprises a seat element 2 with a seating surface 201, on which the thighs and the bottom of the occupant sitting in the vehicle seat are placed. At the rear end of the seat element 2, there is a backrest 3 along which the back of the occupant sitting in the vehicle seat extends. In the embodiment described here, a headrest 4 for holding the head of the occupant is formed at the upper end of the backrest 3. The backrest 3 comprises a rear wall 5 formed in one piece, the outer side 502 of which may be seen in FIG. 1. The outer side constitutes an externally visible region of the rear wall.

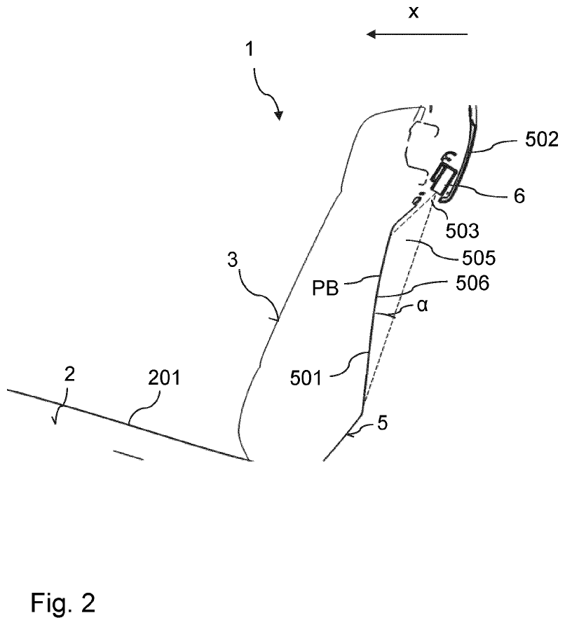

On the inner side 501 of the rear wall, as may be seen for example in FIG. 2, there is a projection module 6 which is indicated in FIG. 1 merely schematically by a hatched rectangle. The projection module is a projection module known from the prior art. It may be based on different technologies. For example, the projection module may be configured in such a way that it contains a DMD device in order to generate a corresponding light projection (DMD=Digital Mirror Device). The projection module may likewise be a scanning projection module, which achieves the light projection by moving a light beam, in particular a laser beam, by way of a scanner. The light field that is generated by the projection module 6 is indicated in FIG. 1 schematically by a plurality of lines L and L′. The lines L′ indicate the edge of the projection region PB on the outer side 502 of the rear wall 5. The light projection that is generated by the projection module 6 lies in the projection region PB.

The projection module 6 is fixed, or rigidly fastened, to the inner side 501 of the rear wall 5 and emits light through a downwardly directed light exit opening 503 in the rear wall 5 toward the outer side 502 of the rear wall. The projection region PB is formed in a recess 505 of the rear wall 5, which is again illustrated in the sectional view of FIG. 2. It can be seen in FIG. 2 that the recess 505 has the downwardly directed light exit opening 503 at its upper edge. In FIG. 2, the light field of the light of the projection module 5 that emerges from the light exit opening 503 is further indicated by two dashed lines. This light field impinges on the projection region PB, which is formed as an oblique portion 506 inside the recess 505 of the rear wall 5. This oblique portion runs at an obtuse angle relative to the light exit opening 503 (i.e. relative to the plane of the light exit opening).

In FIG. 2 the angle a is the smallest projection angle at which the light of the projection module 6 impinges on the projection region PB. In order to reduce distortions in the light projection, this angle preferably lies between 10° and 15°. A further effect of the shaping of the recess 505 is that all the light of the projection module impinges exclusively on the projection region PB. In other words, it ensures that only the rear wall of the vehicle seat is illuminated, and other components in the motor vehicle or the floor of the motor vehicle are not illuminated.

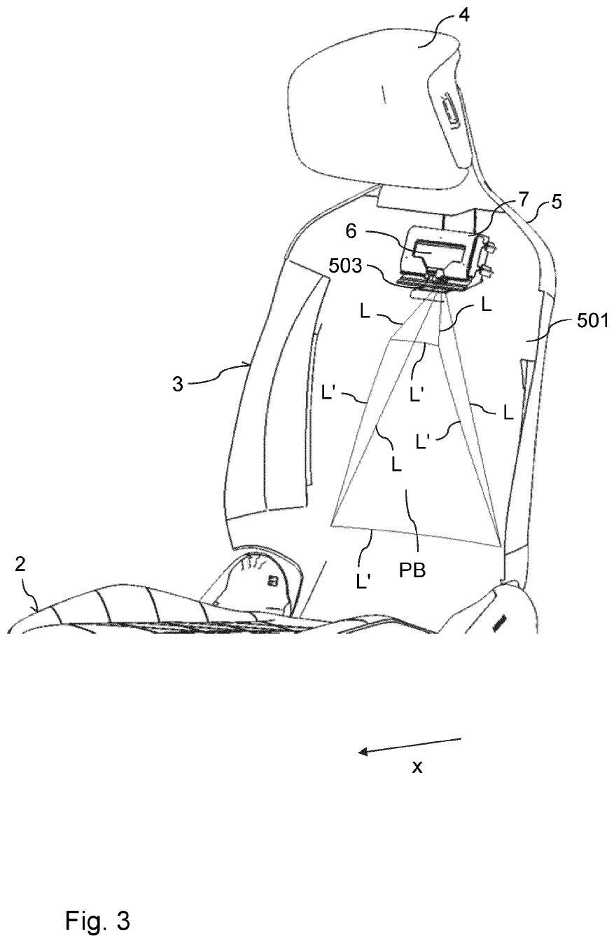

One essential aspect of the embodiment of the invention described here is that the projection module 6 is connected rigidly to the rear wall 5, or fastened rigidly to its inner side 501. Relative movements between the projection module 6 and the rear wall 5 are thereby avoided, so that the light projection is always reproduced at the same place on the rear wall. The rigid fastening of the projection module is achieved in the embodiment described here by a holder 7, which can be seen in FIG. 3. FIG. 3 shows a view of the vehicle seat from the front, the inner side 501 of the rear wall 5 being revealed by omitting the upholstery of the vehicle seat. For illustration, the light field generated by the projection module 6 is again indicated by the lines L and L′, this light field in reality not being visible and being concealed by the rear wall 5.

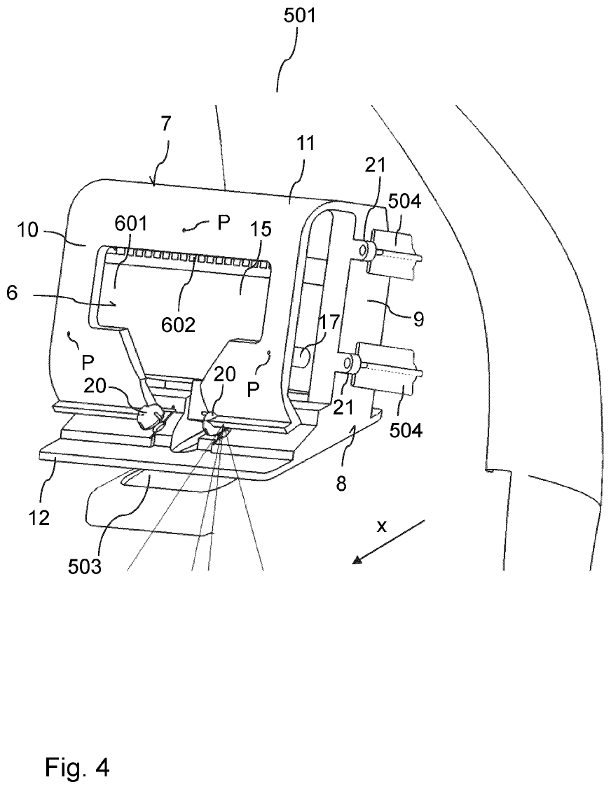

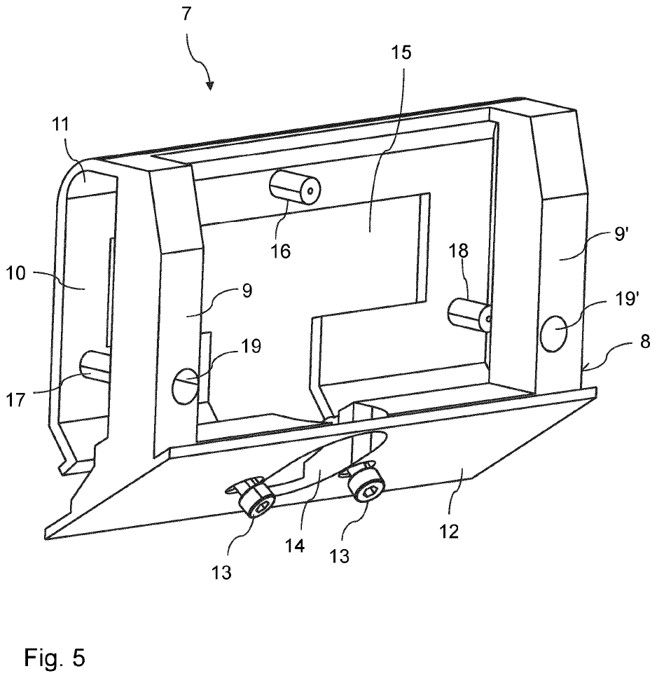

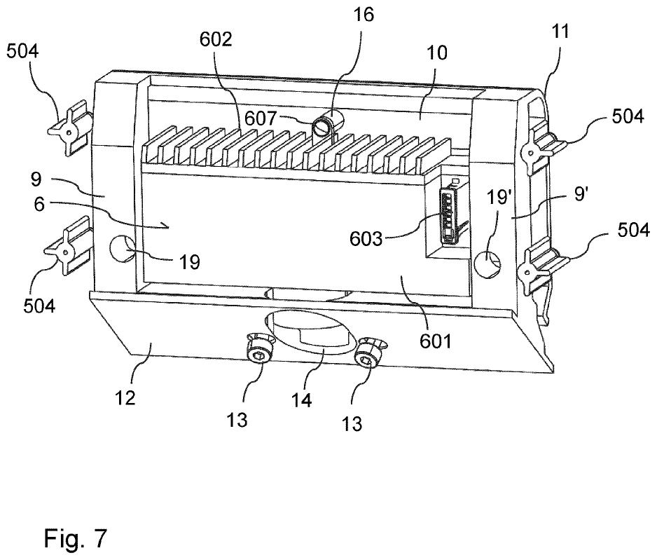

The holder 7 shown in FIG. 3 accommodates the projection module 6 and is connected rigidly to the inner side 501 of the rear wall 5. This may be seen from the detail view according to FIG. 4. The holder comprises a base portion or lower part 8, which comprises two arms 9, 9′ and a platelike portion 12. The arms and the platelike portion can be seen very clearly in the view of FIG. 5. In FIG. 4 only the arms 9 can be seen. A pair of brackets 21 is formed on each of the two arms 9, 9′, only the brackets provided on the arm 9 being visible in FIG. 4. In FIG. 5 as well as in FIG. 7, which is described below, the brackets 21 have been omitted for reasons of clarity. Each of the four brackets 21 bears on a cruciform protrusion 504, which is formed integrally in the rear wall 5. Provided in the respective brackets 21, there is an opening through which the brackets are screwed to the protrusions 504 by way of screws (not shown). Fixing, or rigid fastening, of the holder 7 to the inner side 501 of the rear wall 5 is obtained in this way.

Formed on the front side of the base portion 8 of the holder 7, there is a holding portion 10 which is connected by a resiliently deformable curved portion 11 to the base portion 8. Preferably, the holder 7 is a plastic component, in which case the resilience of the portion 11 may be ensured in a manner known per by a suitable plastic material. Formed on the holding portion 10, there is an open region 15 through which a part of the projection module 6 is exposed. A part of the housing 601 and of the heat sink 602 of the projection module 6, which is provided thereon, can be seen in FIG. 4.

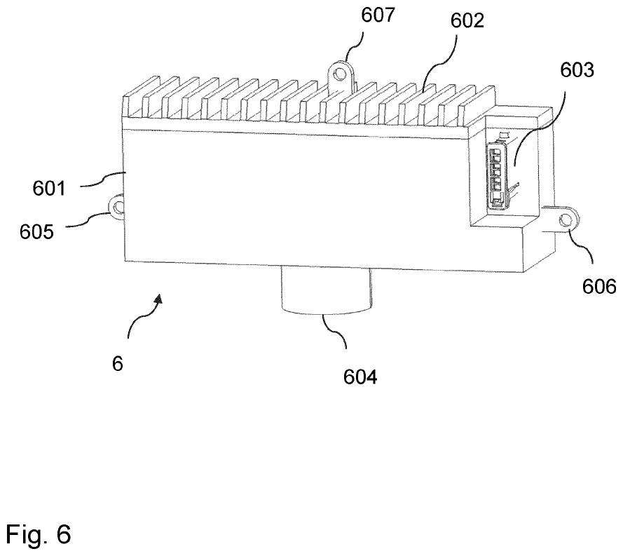

FIG. 6 again shows a perspective representation of the construction of the projection module that is accommodated in the holder 7 of FIG. 4 or FIG. 5. As mentioned, the projection module comprises a housing 601 and a heat sink 602. The optical and electronic components with which the projection module generates a corresponding light projection are installed in the housing. The light of the projection module emerges from its lens 604. The projection module 6 further comprises a coupling element 603, through which the projection module is supplied with power and communicates with a controller of the motor vehicle. The projection module 6 contains a memory which stores different digital images, with which various light projections can be generated in the projection region PB.

Three lugs 605, 606 and 607 with corresponding openings are furthermore provided on the projection module 6. The lugs 605 and 606 are located on two opposite sides of the housing 601, while the lug 607 is formed centrally on the heat sink 602. Using the lugs, the projection module 6 is fastened to the holding portion 10 by way of screws that are inserted into the respective openings of the lugs 605, 606 and 607. In FIG. 4, the reference P indicates the corresponding fastening points of the projection module on the holding portion 10. For fastening the projection module, cylindrical fastening protrusions 16, 17 and 18 that can be seen very clearly in FIG. 5 are formed on holding portion 10. The fastening protrusion 17 is arranged opposite a bore 19 in the arm 9, while the fastening protrusion 18 lies opposite a bore 19′ in the arm 9′.

In order to fasten the projection module 6 in the holder 7, the projection module is arranged between the holding portion 10 and the base portion 8 in such a way that the lugs 605, 606, 607 of the projection module bear on respective fastening protrusions 16, 17, 18. Specifically, the lug 605 is located on the fastening protrusion 17, the lug 606 is located on the fastening protrusion 18 and the lug 607 is located on the fastening protrusion 16. Each lug is subsequently screwed to the corresponding fastening protrusion by way of a screw. This can again be seen very clearly in FIG. 7 for the lug 607 and the fastening protrusion 16. For fastening the lugs 605 and 606 to the fastening protrusions 17 and 18, the corresponding screw is introduced into the bore 19 or 19′ of the respective arm 9, 9′ and then screwed to the respective fastening protrusion 17 or 18. Once the projection module 6 is fitted in the holder 7, its lens 604 is located at the opening 14 that can be seen in FIG. 5 and FIG. 7, which is provided in the platelike portion 12.

An alignment device is further provided in the holder 7, which comprises a pair of adjustment elements in the form of adjustment screws 13 that can be seen in FIG. 5 and FIG. 7. The adjustment screws are screwed into corresponding openings in the platelike portion 12. In other words, the external thread of the respective adjustment screw 13 engages in an internal thread in the corresponding opening. The ends of the adjustment screws that are provided on the opposite side from the screw heads have a thickening in the form of a spherical head, which engages in a corresponding mount or socket 20 and is held there. The mounts 20 can be seen in FIG. 4. As may be seen there, the mounts 20 are formed at a lower end of the holding portion 10 and lie opposite the openings in which the adjustment screws 13 are screwed into the platelike portion 12.

By turning the respective adjustment screw 13, a position variation of its spherical head is obtained, which in turn leads to a position variation of the mount 20 and of the holding portion 10 by resilient deformation of the portion 11. Since the projection module 6 is applied firmly to the holding portion 10, this also varies its position and therefore the angle at which the light generated by the projection module impinges on the rear wall 5. It offers a straightforward way of varying the position of the light projection and, for example, adapting it to differently configured rear walls.

In one preferred configuration, the projection module described above is used to generate ambient interior lighting in the motor vehicle by suitable light projection, which may also be animated. For example, ambient lighting may be provided for a relaxation scenario (relax function) in which the light projection for example depicts an animated campfire. Preferably, the occupants can select a particular scenario with associated light projection if required; when a scenario is selected, not only is the corresponding projection displayed but optionally further actions are also automatically initiated in the motor vehicle. If the driver selects a relaxation scenario via a user interface, for example, besides projecting the campfire the blinds of the windows of the motor vehicle may at the same time be closed and the seats of the motor vehicle may be moved into a relaxed position.

As already mentioned above, various images for generating different projections may be stored in a memory in the projection module 6.

It is optionally also possible that digital images for new projections are installed in the memory of the projection module by coupling the projection module to a controller of the motor vehicle. For example, the user of the motor vehicle may purchase corresponding images in the digital after-sales service, which are then stored in the motor vehicle, or in the memory of the projection module. Furthermore, it is optionally also possible that the user can independently download suitable images for projections to the projection module 6 through their terminal device.

The above-described embodiments of the invention have a range of advantages. In particular, the rigid fastening or connection of the projection module to the rear wall of the vehicle seat ensures that no relative movements occur between the projection module and the rear wall. In other words, the light projection is always reproduced at the same place regardless of the position of the backrest of the vehicle seat. Furthermore, it is scarcely possible for the projection to be masked. It further ensures that no components which lie outside the rear wall of the vehicle seat are illuminated by the light projection.

### LIST OF REFERENCE SIGNS

1 vehicle seat
2 seat element
201 seat surface
3 backrest
4 headrest
5 rear wall
501 inner side of the rear wall
502 outer side of the rear wall
503 light exit opening
504 protrusions
505 recess
506 oblique portion
6 projection module
601 housing
602 heat sink
603 coupling element
604 lens
605, 606, 607 lugs
7 holder
8 base portion
9,9′ struts
10 holding portion
11 resiliently deformable portion
12 platelike portion
13 adjustment elements (adjustment screws)
14 opening
15 opening region
16, 17, 18 fastening protrusions
19, 19′ bores
20 mounts
21 brackets
PB projection region
L, L′ lines
P fastening points
X driving direction

1.-15. (canceled)

16. A lighting device for a motor vehicle, the lighting device comprising:
a vehicle seat for an occupant of the motor vehicle, wherein:
the vehicle seat comprises a seat element having a seat surface and a backrest,
the backrest has a rear wall with an inner side and an outer side,
the rear wall extends from a first end which is arranged next to the seat element, to a second end which is arranged away from the seat element,
a projection module is installed in the vehicle seat, and
the projection module is fixed to the inner side of the rear wall in a fastening position so that light which is generated by the projection module during its operation emerges from a light exit opening in the rear wall in order to generate a light projection in a projection region on the outer side of the rear wall.

17. The lighting device according to claim 16, wherein the light emerging from the light exit opening impinges exclusively on the projection region.

18. The lighting device according to claim 16, wherein the light exit opening is directed toward the first end of the rear wall.

19. The lighting device according to claim 16, wherein the rear wall is shaped such that a smallest angle of incidence at which the light that generates the light projection impinges on the projection region lies between 10° and 15°.

20. The lighting device according to claim 16, wherein a recess, in which the projection region is located, is formed in the outer side of the rear wall.

21. The lighting device according to claim 20, wherein the light exit opening is provided in an edge region of the recess that lies opposite an oblique portion of the recess, the oblique portion being inclined relative to the light exit opening at an angle of inclination of less than 90° and containing the projection region.

22. The lighting device according to claim 16, wherein the projection module is accommodated in a holder that is applied to the inner side of the rear wall.

23. The lighting device according to claim 22, wherein the holder is fastened to a plurality of protrusions provided on the rear wall.

24. The lighting device according to claim 16, wherein an alignment device for varying the fastening position of the projection module is provided, in order to vary a direction of the light emerging from the light exit opening and thereby the projection region on the outer side of the rear wall.

25. The lighting device according to claim 24, wherein the alignment device comprises one or more settable adjustment elements, which mechanically interact with the holder such that a variation of the fastening position of the projection module is achievable by setting the one or more settable adjustment elements.

26. The lighting device according to claim 25, wherein the holder has a holding portion to which the projection module is fastened, a resiliently deformable portion of the holder being adjacent to a first end of the holding portion and the one or more settable adjustment elements engaging in the holding portion at a second end of the holding portion, which lies opposite the first end, in which case by setting the one or more settable adjustment elements the variation of the fastening position of the projection module is achievable by varying a resilient deformation of the resiliently deformable portion.

27. The lighting device according to claim 26, wherein each adjustment element of the one or more settable adjustment elements is an adjustment screw having a first end and an opposite second end, the screw head being located at the first end.

28. The lighting device according to claim 27, wherein each adjustment screw is screwed in the holder and comprises a thickening at its second end, the thickening being held in a mount at the second end of the holding portion, a force that the respective adjustment screw exerts on the holding portion being variable by turning the respective adjustment screw, so that the variation of the fastening position of the projection module is achievable by varying the resilient deformation of the resiliently deformable portion.

29. The lighting device according to claim 16, wherein the rear wall is a plastic component.

30. The lighting device according to claim 29, wherein the rear wall is an injection molded component.

31. The lighting device according to claim 16, wherein the projection module is configured such that an animated light projection is generated in the projection region.

32. The motor vehicle comprising the lighting device according to claim 16.
